(19) United States
(12) Patent Application Publication
(10) Pub. No.: US 2023/0328828 A1
(43) Pub. Date: Oct. 12, 2023

(54) METHODS AND APPARATUSES FOR A RELAY RESELECTION AND CONNECTION HANDLING PROCEDURE IN A UE-TO-UE RELAY SCENARIO

(71) Applicant: Lenovo (Beijing) Limited, Beijing (CN)

(72) Inventors: Lianhai Wu, Beijing (CN); Congchi Zhang, Shanghai (CN); Mingzeng Dai, Shanghai (CN); Jing Han, Beijing (CN)

(73) Assignee: Lenovo (Beijing) Limited, Beijing (CN)

(21) Appl. No.: 18/044,513

(22) PCT Filed: Sep. 27, 2020
(86) PCT No.: PCT/CN2020/118147

§ 371 Date: Mar. 8, 2023

(51) Int. Cl. H04W 76/18; H04W 76/38; H04W 76/14

(52) U.S. Cl. CPC H04W 76/18; H04W 88/04; H04W 76/14; H04W 76/38

(57) ABSTRACT

Various aspects of the present application relate to methods and apparatuses for a relay reselection and connection handling procedure in a user equipment (UE)-to-UE relay scenario. A method includes establishing a PC5 radio resource control (RRC) connection of a first link between the UE and a relay UE, a RRC connection of a second link between the relay UE and another UE having been established. The method includes performing a relay reselection procedure based on a trigger condition as at least one of: detecting a sidelink failure; detecting a failure in a RRC relayed connection of a third link between the UE and the another UE; receiving a failure notification from the relay UE; or receiving a failure indication from an upper layer of the UE.

### TECHNICAL FIELD

Embodiments of the present application generally relate to wireless communication technology, especially to methods and apparatuses for a relay reselection and connection handling procedure in a user equipment (UE)-to-UE relay scenario.

### BACKGROUND

Vehicle to everything (V2X) has been introduced into 5G wireless communication technology. In terms of a channel structure of V2X communication, the direct link between two user equipments (UEs) is called a sidelink. A sidelink is a long-term evolution (LTE) feature introduced in 3GPP Release 12, and enables a direct communication between proximal UEs, and data does not need to go through a base station (BS) or a core network.

In the 3rd Generation Partnership Project (3GPP), deployment of a relay node (RN) in a wireless communication system is promoted. One objective of deploying a RN is to enhance the coverage area of a BS by improving the throughput of a UE that is located in the coverage or far from the BS, which can result in relatively low signal quality. A RN may also be named as a relay UE in some cases. A 3GPP 5G sidelink system including a relay UE may be named as a sidelink relay system.

Currently, in a 3GPP 5G New Radio (NR) system or the like, details regarding how to design a relay reselection and connection handling procedure in a UE-to-UE relay scenario have not been specifically discussed yet.

### SUMMARY

Some embodiments of the present application provide a method for wireless communications. The method may be performed by a UE. The method includes: establishing a PC5 radio resource control (RRC) connection of a link between the UE and a relay UE, wherein a RRC connection of a link between the relay UE and another UE has been established; and performing a relay reselection procedure based on a trigger condition, wherein the trigger condition is at least one of: detecting a sidelink failure; detecting a failure in a RRC relayed connection of a link between the UE and the abovementioned another UE; a reception of a failure notification from the relay UE; and a reception of a failure indication from an upper layer of the UE.

In some embodiments, in the method performed by the UE, the failure notification received from the relay UE is one of: a sidelink radio link failure (RLF) notification associated with the link between the relay UE and the abovementioned another UE; a notification of failing to recover a sidelink RLF on the link between the relay UE and the abovementioned another UE; and a notification of a PC5-signaling (PC5-S) link failure on the link between the relay UE and the abovementioned another UE.

In some embodiments, in the method performed by the UE, the notification of the PC5-S link failure is received after an access stratum (AS) layer of the relay UE receives an indication of the PC5-S link failure. In some other embodiments, the notification of the PC5-S link failure is received after an expiry of “a timer of keep-alive procedure”.

In some embodiments, in the method performed by the UE, the sidelink RLF notification includes a cause, and the cause is at least one of: reaching a maximum number of radio link control (RLC) retransmission; an expiry of “a timer for transmission of RRC reconfiguration for sidelink”; reaching a maximum number of consecutive hybrid automatic repeat request (HARQ) discontinuous transmission (DTX); a reception of an integrity check failure indication; and an occurrence of the PC5-S link failure.

In some embodiments, the PC5-S link failure is detected upon at least one of: an expiry of “a timer for keep-alive procedure” which is associated with the link between the UE and the relay UE; and an expiry of “another timer for keep-alive procedure” which is associated with the link between the UE and the abovementioned another UE.

In some embodiments, in the method performed by the UE, the failure indication is received from a PC5-S layer of the UE, and the failure indication is an indication of the PC5-S link failure of the link between the UE and relay UE, wherein the indication is received by a AS layer of the UE from a PC5-S layer of the UE.

In some embodiments, in the method performed by the UE, the sidelink failure occurs in the link between the UE and the relay UE, and the sidelink failure is at least one of: a RLF in the link between the UE and the relay UE; and a failure regarding configuration information, and the configuration information is associated with the link between the UE and the relay UE.

In some embodiments, in the method performed by the UE, the failure in the RRC relayed connection of the link between the UE and the abovementioned another UE is detected upon at least one of: an expiry of “a timer for RRC reconfiguration procedure”, which is associated with the RRC relayed connection of the link between the UE and the abovementioned another UE; and an expiry of “a timer for keep-alive procedure”, which is associated with the link between the UE and the abovementioned another UE.

In some embodiments, in the method performed by the UE, in response to an expiry of “a timer for keep-alive procedure” which is associated with the link between the relay UE and the abovementioned another UE, the failure notification is indicated from an upper layer of the relay UE to a AS layer of the relay UE, and the failure notification is transmitted by the relay UE to the UE.

In some embodiments, the method performed by the UE further comprises: in response to receiving the failure notification associated with the sidelink failure in the link between the relay UE and the abovementioned another UE, suspending a transmission of data terminated in the abovementioned another UE.

In some embodiments, the method performed by the UE further comprises: in response to receiving the failure notification associated with the sidelink failure in the link between the relay UE and the abovementioned another UE, continuing to transmit data terminated in the relay UE and continuing to receive data from the relay UE.

In some embodiments, the method performed by the UE further comprises: stopping receiving data from the relay UE in response to: receiving an end-mark indication from the relay UE; or receiving a RRC message including an indication of completing data forwarding terminated in the UE.

In some embodiments, the method performed by the UE further comprises releasing the PC5 RRC connection between the UE and the relay UE.

In some embodiments, the method performed by the UE further comprises transmitting, by an AS layer of the UE, an indication to a PC5-S layer of the UE, wherein the indication indicates that the UE has stopped receiving the data from the relay UE.

In some embodiments, the method performed by the UE further comprises reporting failure information to a base station (BS) in response to: the UE being in coverage of the BS; and detecting the sidelink failure in the link between the UE and the relay UE or detecting the failure in the RRC relayed connection of the link between the UE and the abovementioned another UE.

In some embodiments, the failure information includes a failure cause, and the failure cause is at least one of: a failure regarding configuration information, and the configuration information is associated with the link between the UE and the relay UE; the sidelink failure in the link between the UE and the relay UE; the sidelink failure in the link between the relay UE and the abovementioned another UE; and the failure in a RRC relayed connection of the link between the UE and the abovementioned another UE.

In an embodiment, the failure information includes a set of identity information regarding two terminated UEs of a link associated with the failure cause.

In some embodiments, the method performed by the UE further comprises: reporting the failure notification to a BS in response to: the UE being in coverage of the BS; and receiving the failure notification from the relay UE.

In some embodiments, the failure notification includes a failure cause, and the failure cause is at least one of: a failure regarding configuration information, and the configuration information is associated with the link between the UE and the relay UE; the sidelink failure in the link between the UE and the relay UE; the sidelink failure in the link between the relay UE and the abovementioned another UE; and the failure in a RRC relayed connection of the link between the UE and the abovementioned another UE. In an embodiment, the failure notification includes a set of identity information regarding two terminated UEs of a link associated with the failure cause.

Some embodiments of the present application also provide an apparatus for wireless communications. The apparatus includes: a non-transitory computer-readable medium having stored thereon computer-executable instructions; a receiving circuitry; a transmitting circuitry; and a processor coupled to the non-transitory computer-readable medium, the receiving circuitry and the transmitting circuitry, wherein the computer-executable instructions cause the processor to implement any of the above-mentioned method performed by a UE.

Some embodiments of the present application provide a further method for wireless communications. The method may be performed by a relay UE. The method includes: establishing a PC5 radio resource control (RRC) connection of a link between a UE and the relay UE; establishing a RRC connection of a link between the relay UE and another UE; and transmitting a failure notification to the UE.

In some embodiments, in the method performed by the relay UE, the failure notification transmitted from the relay UE is one of: a sidelink RLF notification associated with the link between the relay UE and the abovementioned another UE; a notification of failing to recover a sidelink RLF on the link between the relay UE and the abovementioned another UE; and a notification of a PC5-S link failure on the link between the relay UE and the abovementioned another UE.

In an embodiment, the sidelink RLF notification includes a cause, and the cause is at least one of: reaching a maximum number of RLC retransmission; an expiry of “a timer for transmission of RRC reconfiguration for sidelink”; reaching a maximum number of consecutive HARQ DTX; a reception of an integrity check failure indication; and an occurrence of the PC5-S link failure.

In some embodiments, in the method performed by the relay UE, the step of transmitting the failure notification to the UE further comprises: receiving, by an AS layer of the relay UE, an indication of the PC5-S link failure on the link between the relay UE and the abovementioned another UE; and transmitting the notification of the PC5-S link failure to the UE.

In some other embodiments, in the method performed by the relay UE, the step of transmitting the failure notification to the UE further comprises: detecting an expiry of “a timer of keep-alive procedure”, which is associated with the link between the relay UE and the abovementioned another UE; and transmitting the notification of the PC5-S link failure to the UE.

Some embodiments of the present application also provide an apparatus for wireless communications. The apparatus includes: a non-transitory computer-readable medium having stored thereon computer-executable instructions; a receiving circuitry; a transmitting circuitry; and a processor coupled to the non-transitory computer-readable medium, the receiving circuitry and the transmitting circuitry, wherein the computer-executable instructions cause the processor to implement any of the above-mentioned method performed by a relay UE.

The details of one or more examples are set forth in the accompanying drawings and the descriptions below. Other features, objects, and advantages will be apparent from the descriptions and drawings, and from the claims.

### BRIEF DESCRIPTION OF THE DRAWINGS

In order to describe the manner in which advantages and features of the application can be obtained, a description of the application is rendered by reference to specific embodiments thereof, which are illustrated in the appended drawings. These drawings depict only example embodiments of the application and are not therefore to be considered limiting of its scope.

FIG. 1 illustrates a schematic diagram of a wireless communication system in accordance with some embodiments of the present application;

FIG. 2 illustrates an exemplary V2X communication system in accordance with some embodiments of the present application;

FIG. 3 illustrates an exemplary flowchart of a sidelink RRC reconfiguration procedure in accordance with some embodiments of the present application;

FIG. 4 illustrates an exemplary flowchart of a sidelink UE information procedure in accordance with some embodiments of the present application;

FIG. 5 illustrates an exemplary flowchart of a Layer-2 link maintenance procedure in accordance with some embodiments of the present application;

FIG. 6 illustrates an exemplary Layer 2 UE-to-UE relay protocol stack in accordance with some embodiments of the present application;

FIG. 7 illustrates a flow chart of a method for performing a relay reselection procedure in accordance with some embodiments of the present application;

FIG. 8 illustrates a flow chart of a method for transmitting a failure notification in accordance with some embodiments of the present application;

FIG. 9 illustrates a flow chart of a method for reporting failure information in accordance with some embodiments of the present application; and

FIG. 10 illustrates a simplified block diagram of an apparatus for a failure handling procedure in accordance with some embodiments of the present application.

### DETAILED DESCRIPTION

The detailed description of the appended drawings is intended as a description of preferred embodiments of the present application and is not intended to represent the only form in which the present application may be practiced. It should be understood that the same or equivalent functions may be accomplished by different embodiments that are intended to be encompassed within the spirit and scope of the present application.

Reference will now be made in detail to some embodiments of the present application, examples of which are illustrated in the accompanying drawings. To facilitate understanding, embodiments are provided under specific network architecture and new service scenarios, such as 3GPP 5G, 3GPP LTE Release 8 and so on. It is contemplated that along with developments of network architectures and new service scenarios, all embodiments in the present application are also applicable to similar technical problems; and moreover, the terminologies recited in the present application may change, which should not affect the principle of the present application.

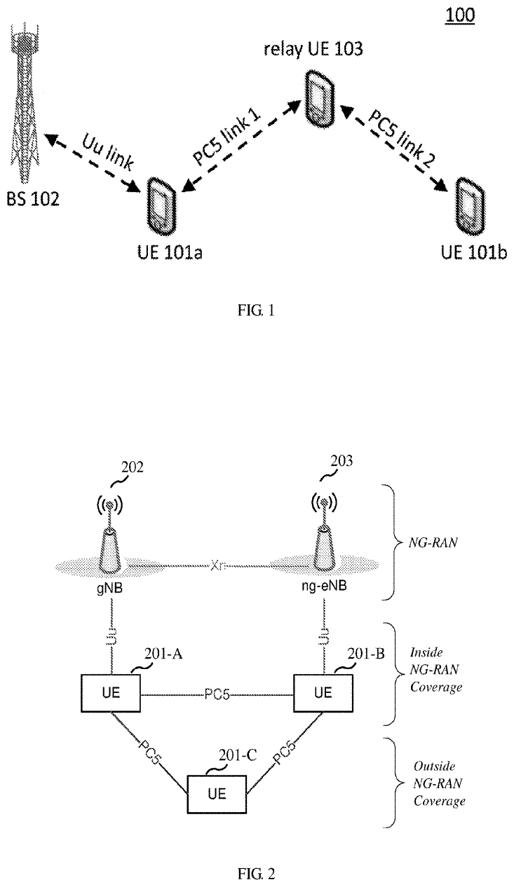

FIG. 1 illustrates a schematic diagram of a wireless communication system in accordance with some embodiments of the present application.

As shown in FIG. 1, the wireless communication system 100 includes two UEs (i.e., UE 101a and UE 101b), a BS 102, and a relay UE 103 for illustrative purpose. Although a specific number of UE(s), relay UE(s), and BS(s) are depicted in FIG. 1, it is contemplated that any number of UE(s), relay UE(s), and BS(s) may be included in the wireless communication system 100.

Due to a far distance between UE 101a and UE 101b, these two UEs communicate with each other via relay UE 103. UE 101a and UE 101b may be connected to relay UE 103 via a network interface, for example, a PC5 interface as specified in 3GPP standard documents. UE 101a may be connected to the BS 102 via a network interface, for example, a Uu interface as specified in 3GPP standard documents. Referring to FIG. 1, UE 101a is connected to relay UE 103 via PC5 link 1, UE 101b is connected to relay UE 103 via PC5 link 2, and UE 101a is connected to the BS 102 via a Uu link.

In some embodiments of the present application, UE 101a, UE 101b, or relay UE 103 may include computing devices, such as desktop computers, laptop computers, personal digital assistants (PDAs), tablet computers, smart televisions (e.g., televisions connected to the Internet), set-top boxes, game consoles, security systems (including security cameras), vehicle on-board computers, network devices (e.g., routers, switches, and modems), or the like.

In some further embodiments of the present application, UE 101a, UE 101b, or relay UE 103 may include a portable wireless communication device, a smart phone, a cellular telephone, a flip phone, a device having a subscriber identity module, a personal computer, a selective call receiving circuitry, or any other device that is capable of sending and receiving communication signals on a wireless network.

In some other embodiments of the present application, UE 101a, UE 101b, or relay UE 103 may include wearable devices, such as smart watches, fitness bands, optical head-mounted displays, or the like. Moreover, UE 101a, UE 101b, or relay UE 103 may be referred to as a subscriber unit, a mobile, a mobile station, a user, a terminal, a mobile terminal, a wireless terminal, a fixed terminal, a subscriber station, a user terminal, or a device, or described using other terminology used in the art.

BS(s) 102 may be distributed over a geographic region. In certain embodiments of the present application, each of the BS(s) 102 may also be referred to as an access point, an access terminal, a base, a base unit, a macro cell, a Node-B, an evolved Node B (eNB), a gNB, a Home Node-B, a relay node, or a device, or described using other terminology used in the art. BS(s) 102 is generally a part of a radio access network that may include one or more controllers communicably coupled to one or more corresponding BS(s) 102.

The wireless communication system 100 may be compatible with any type of network that is capable of sending and receiving wireless communication signals. For example, the wireless communication system 100 is compatible with a wireless communication network, a cellular telephone network, a Time Division Multiple Access (TDMA)-based network, a Code Division Multiple Access (CDMA)-based network, an Orthogonal Frequency Division Multiple Access (OFDMA)-based network, an LTE network, a 3GPP-based network, a 3GPP 5G network, a satellite communications network, a high altitude platform network, and/or other communications networks.

In some embodiments of the present application, the wireless communication system 100 is compatible with the 5G NR of the 3GPP protocol, wherein BS(s) 102 transmit data using an OFDM modulation scheme on the downlink (DL), and UE(s) 101 (e.g., UE 101a, UE 101b, or other similar UE) transmit data on the uplink (UL) using a Discrete Fourier Transform-Spread-Orthogonal Frequency Division Multiplexing (DFT-S-OFDM) or cyclic prefix-OFDM (CP-OFDM) scheme. More generally, however, the wireless communication system 100 may implement some other open or proprietary communication protocols, for example, WiMAX, among other protocols.

In some embodiments of the present application, BS(s) 102 may communicate using other communication protocols, such as the IEEE 802.11 family of wireless communication protocols. Further, in some embodiments of the present application, BS(s) 102 may communicate over licensed spectrums, whereas in other embodiments, BS(s) 102 may communicate over unlicensed spectrums. The present application is not intended to be limited to the implementation of any particular wireless communication system architecture or protocol. In yet some embodiments of present application, BS(s) 102 may communicate with UE(s) 101 using the 3GPP 5G protocols.

UE(s) 101 may access BS(s) 102 to receive data packets from BS(s) 102 via a downlink channel and/or transmit data packets to BS(s) 102 via an uplink channel. In normal operation, since UE(s) 101 does not know when BS(s) 102 will transmit data packets to it, UE(s) 101 has to be awake all the time to monitor the downlink channel (e.g., a physical downlink control channel (PDCCH)) to get ready for receiving data packets from BS(s) 102. However, if UE(s) 101 keeps monitoring the downlink channel all the time even when there is no traffic between BS(s) 102 and UE(s) 101, it would result in significant power waste, which is problematic to a power limited UE or a power sensitive UE.

Generally, sidelink communication supports UE-to-UE direct communication using two transmission modes. Two sidelink resource allocation modes are supported, namely, mode 1 and mode 2. In mode 1, the sidelink resource is scheduled by the BS. In mode 2, a UE decides the sidelink transmission resources and timing in the resource pool based on the measurement result and sensing result. Sidelink communication includes NR sidelink communication and V2X sidelink communication. FIG. 2 below demonstrates the NR sidelink communication. V2X sidelink communication is specified in 3GPP TS 36.300.

FIG. 2 illustrates an exemplary V2X communication system in accordance with some embodiments of the present application.

As shown in FIG. 2, the V2X communication system includes one gNB 202, one ng-eNB 203, and some V2X UEs, i.e., UE 201-A, UE 201-B, and UE 201-C. Each of these UEs may refer to UE 101a, UE 101b, or relay UE 103 as shown and illustrated in FIG. 1.

In particular, UE 201-A is within the coverage of gNB 202, UE 201-B is within the coverage of ng-eNB 203, and UE 201-C is out of coverage of gNB 202 and ng-eNB 203. Support of V2X services via the PC5 interface can be provided by NR sidelink communication and/or V2X sidelink communication. NR sidelink communication can support one of three types of transmission modes for a pair of a Source Layer-2 identity (ID) and a Destination Layer-2 ID: unicast transmission; groupcast transmission; and broadcast transmission. Sidelink transmission and reception over the PC5 interface are supported when the UE is either inside of the NG-RAN coverage or outside of the NG-RAN coverage.

UE 201-A, which is in the coverage of within the coverage of gNB 202, may perform sidelink unicast transmission, sidelink groupcast transmission, or sidelink broadcast transmission over the PC5 interface. UE 201-C, which is out of coverage, can also perform sidelink transmission and reception over the PC5 interface. It is contemplated that, in accordance with some other embodiments of the present application, a V2X communication system may include more or fewer BSs, and more or fewer V2X UEs. Moreover, it is contemplated that names of V2X UEs (which represent a Tx UE, a Rx UE, and etc.) as illustrated and shown in FIG. 2 may be different, e.g., UE 201c, UE 204f, and UE 208g or the like.

In addition, although each V2X UE as shown in FIG. 2 is illustrated in the shape of a cell phone, it is contemplated that a V2X communication system may include any type of UE (e.g., a roadmap device, a cell phone, a computer, a laptop, IoT (internet of things) device or other type of device) in accordance with some other embodiments of the present application.

According to some embodiments of FIG. 2, UE 201-A functions as a Tx UE, and UE 201-B and UE 201-C function as a Rx UE. UE 201-A may exchange V2X messages with UE 201-B, or UE 201-C through a sidelink, for example, PC5 interface as defined in 3GPP TS 23.303. UE 201-A may transmit information or data to other UE(s) within the V2X communication system, through sidelink unicast, sidelink groupcast, or sidelink broadcast. The sidelink communication includes NR sidelink communication, and V2X sidelink communication. For instance, UE 201-A may transmit data to UE 201-C in a NR sidelink unicast session, and UE 201-B may transmit data to UE 201-C in a V2X sidelink unicast session. UE 201-A may transmit data to UE 201-B and UE 201-C in a groupcast group by a sidelink groupcast transmission session.

Sidelink communication includes NR Sidelink communication and V2X Sidelink communication. FIG. 2 demonstrates the NR Sidelink communication specified in 3GPP TS 38.311. V2X sidelink communication is specified in 3GPP TS 36.311.

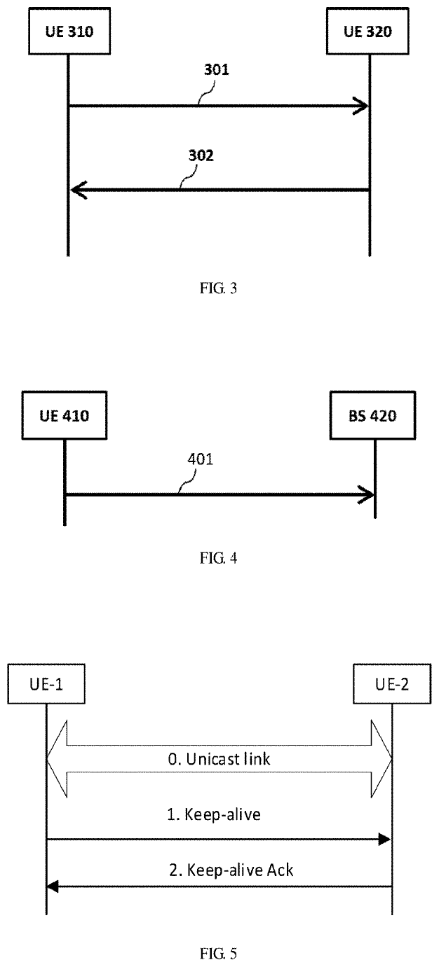

FIG. 3 illustrates an exemplary flowchart of a sidelink RRC reconfiguration procedure in accordance with some embodiments of the present application.

As shown in FIG. 3, in operation 301, UE 310 (e.g., UE 101a as illustrated and shown in FIG. 1) initiates a sidelink RRC reconfiguration procedure to UE 320 (e.g., relay UE 103 as illustrated and shown in FIG. 1) by transmitting RRCReconfigurationSidelink message to UE 320.

If the sidelink RRC reconfiguration procedure is successfully completed, in operation 302, UE 320 may transmit “a RRC reconfiguration complete sidelink message” to UE 310, e.g., RRCReconfigurationCompleteSidelink message as specified in 3GPP standard documents. Alternatively, if the sidelink RRC reconfiguration procedure is not successfully completed, in operation 302, UE 320 may transmit “a RRC reconfiguration failure sidelink message” to UE 310, e.g., RRCReconfigurationFailureSidelink message as specified in 3GPP standard documents.

The purpose of a sidelink RRC reconfiguration procedure is to modify a PC5 RRC connection, e.g., to establish, modify, or release sidelink data radio bearers (DRBs), to configure NR sidelink measurement and reporting, and to configure sidelink channel state information (CSI) reference signal resources.

A UE (e.g., UE 310 as illustrated and shown in FIG. 3) may initiate the sidelink RRC reconfiguration procedure and perform operations on the corresponding PC5 RRC connection in following cases:
a release of sidelink DRBs associated with a peer UE (e.g., UE 320 as illustrated and shown in FIG. 3);
an establishment of sidelink DRBs associated with the peer UE;
a modification for the parameters included in Sidelink radio bearer (SLRB)-Config of sidelink DRBs associated with the peer UE;
configuration information of the peer UE to perform NR sidelink measurement and report; and
configuration information of the sidelink CSI reference signal resources.

A UE capable of NR sidelink communication may initiate a procedure of sidelink UE information for NR, to report to a network or a BS that a sidelink radio link failure (RLF) (e.g., timer T400 expiry) or a sidelink RRC reconfiguration failure has been declared.

The following table shows an introduction of timer T400 as specified in 3GPP standard documents, including a starting condition, a stop condition, an operation at expiry, and a possible general name for the timer.

| Timer | Start | Stop | At expiry | Name |
|---|---|---|---|---|
| T400 | upon | upon reception of | perform the sidelink | a timer for |
| | transmission | RRCReconfiguration | RRC reconfiguration | transmission |
| | of | FailureSidelink or | failure procedure as | of RRC |
| | RRCReconfigurationSidelink | RRCReconfiguration | specified in sub-clause | reconfiguration |
| | | CompleteSidelink | 5.8.9.1.8 of TS38.331 | for |
| | | | | sidelink |

FIG. 4 illustrates an exemplary flowchart of a sidelink UE information procedure in accordance with some embodiments of the present application.

As shown in FIG. 4, in operation 401, UE 410 (e.g., UE 101a as illustrated and shown in FIG. 1 or UE 310 as illustrated and shown in FIG. 3) transmits “a sidelink UE information message” to BS 420 (e.g., BS 102 as illustrated and shown in FIG. 1), e.g., SidelinkUEinformationNR message as specified in 3GPP standard documents. Specifically, the SidelinkUEinformationNR message may include sidelink failure information. The sidelink failure information may include a sidelink destination ID and a sidelink failure cause.

According to 3GPP standard documents, in a keep-alive procedure in a PC5-S layer, the PC5-S protocol shall support keep-alive functionality that is used to detect if a particular PC5 unicast link is still valid. UE(s) shall minimize the keep-alive signaling, e.g., cancel the procedure if data are successfully received over the PC5 unicast link.

FIG. 5 illustrates an exemplary flowchart of a Layer-2 link maintenance procedure in accordance with some embodiments of the present application.

As shown in FIG. 5, in step 0, UE-1 (e.g., UE 101a, UE 201-C, UE 310, or UE 410 as illustrated and shown in FIGS. 1-4) and UE-2 (e.g., relay UE 103, UE 201-A, or UE 320 as illustrated and shown in FIGS. 1-3) have a unicast link established. In step 1, UE-1 (e.g., UE 101a as illustrated and shown in FIG. 1) sends a Keep-alive message to UE-2 (e.g., relay UE 103 as illustrated and shown in FIG. 1) in order to determine the status of the PC5 unicast link based on the trigger condition. In step 2, upon receiving the Keep-alive message, UE-2 responds with a Keep-alive Ack message to UE-1. When UE-1 receives the response from UE-2, UE-1 stops “a timer for keep-alive procedure”. Otherwise, “the timer for keep-alive procedure” expires.

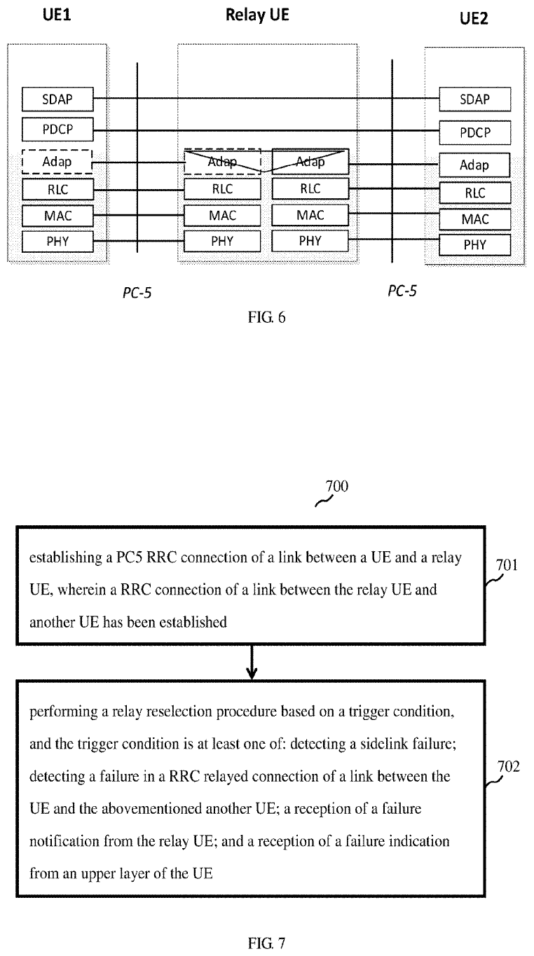

FIG. 6 illustrates an exemplary Layer 2 UE-to-UE relay protocol stack in accordance with some embodiments of the present application.

The embodiments of FIG. 6 show protocol stacks at each side of UE1 (e.g., UE 101a, UE 201-C, UE 310, or UE 410 as illustrated and shown in FIGS. 1-4), a relay UE (e.g., relay UE 103, UE 201-A, or UE 320 as illustrated and shown in FIGS. 1-3), and UE2 (e.g., UE 101b as illustrated and shown in FIG. 1 or UE 320 as illustrated and shown in FIG. 3). Each of UE1 and UE2 is connected to the relay UE via a PC-5 interface, which may also be named as a PC5 interface.

An adaptation layer is supported over another PC5 link (i.e. the PC5 link between Relay UE and Destination UE) for Layer 2 (i.e., L2) UE-to-UE Relay. For L2 UE-to-UE Relay, the adaptation layer is put over a RLC sublayer for both control plane (CP) and user plane (UP) over the abovementioned another PC5 link. The sidelink service data adaptation protocol (SDAP) or the sidelink packet data convergence protocol (PDCP) and RRC are terminated between two Remote UEs, while RLC, MAC and PHY are terminated in each PC5 link.

In particular, as shown in FIG. 6, the UE1 side includes protocol layers of PHY, MAC, RLC, Adaptation layer, PDCP, and SDAP. The relay UE side includes protocol layers of PHY, MAC, RLC, and Adaptation layer. The UE2 side includes protocol layers of PHY, MAC, RLC, Adaptation layer, PDCP, and SDAP.

Regarding Layer 3 (i.e., L3) UE-to-UE relay protocol stack, a relay UE has full protocol stack. Namely, the user plane (UP) protocol stack of L3 relay UE includes the PHY, MAC, RLC, PDCP and SDAP layer. The control plane (CP) protocol stack of L3 relay UE includes the PHY, MAC, RLC, PDCP and RRC layer.

Currently, in a sidelink relay system under 3GPP 5G NR, following issues need to be solved: what is the trigger condition to perform relay reselection; what is the condition to trigger a relay UE to transmit a notification of a failure for Layer-2 link; what is a UE's behavior(s) after the UE receives a failure notification of a link between a relay UE and another UE; and whether does UE report failure information of an end-to-end relayed connection to a BS. Details regarding how to design a relay reselection procedure and a connection handling procedure in a UE-to-UE relay scenario have not been specifically discussed yet. Embodiments of the present application provide a relay reselection and connection handling procedure in a UE-to-UE relay scenario in a 3GPP 5G NR system or the like to solve the above issues. More details will be illustrated in the following text in combination with the appended drawings.

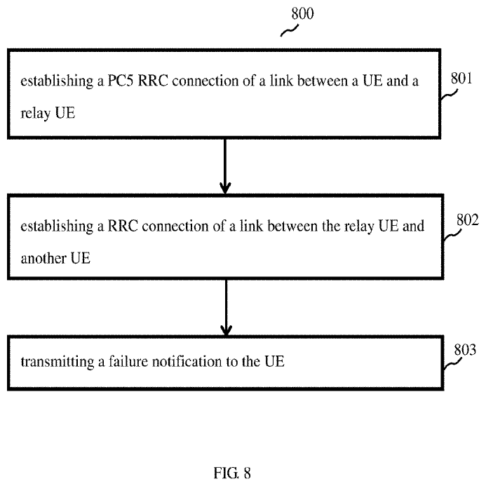

FIG. 7 illustrates a flow chart of a method for performing a relay reselection procedure in accordance with some embodiments of the present application. The method may be performed by a UE (e.g., UE 101a as illustrated and shown in FIG. 1, UE 201-C as illustrated and shown in FIG. 2, UE 310 as illustrated and shown in FIG. 3, or UE 410 as illustrated and shown in FIG. 4). Although described with respect to a UE, it should be understood that other devices may be configured to perform a method similar to that of FIG. 7.

In the exemplary method 700 as shown in FIG. 7, in operation 701, a UE (e.g., UE 101a illustrated and shown in FIG. 1) establishes a PC5 RRC connection of a link between a UE and a relay UE (e.g., relay UE 103 as illustrated and shown in FIG. 1). The embodiments of FIG. 7 assume that a PC5 RRC connection of a link between the relay UE and another UE (e.g., UE 101b illustrated and shown in FIG. 1) has been established.

In operation 702, the UE performs a relay reselection procedure based on a trigger condition. For instance, the trigger condition may be at least one of:
(1) Detecting a sidelink failure. For example, the sidelink failure occurs in the link between the UE and the relay UE. The sidelink failure may be at least one of: a RLF in the link between the UE and the relay UE; and a failure regarding configuration information, and the configuration information is associated with the link between the UE and the relay UE.
(2) Detecting a failure in a RRC relayed connection of a link between the UE and the abovementioned another UE. For example, the failure in the RRC relayed connection of the link between the UE and the abovementioned another UE is detected upon at least one of: an expiry of “a further timer for RRC reconfiguration procedure” which is associated with the RRC relayed connection of the link between the UE and the abovementioned another UE; and an expiry of “an additional timer for keep-alive procedure” which is associated with the link between the UE and the abovementioned another UE.
(3) A reception of a failure notification from the relay UE.
(4) A reception of a failure indication from an upper layer of the UE.

In some embodiments, the failure notification received from the relay UE is one of:
(1) A sidelink RLF notification associated with the link between the relay UE and the abovementioned another UE. In an example, the sidelink RLF notification includes a cause. The cause is at least one of: reaching a maximum number of RLC retransmission; an expiry of “a timer for transmission of RRC reconfiguration for sidelink”; reaching a maximum number of consecutive HARQ DTX; a reception of an integrity check failure indication; and an occurrence of a PC5-S link failure. A PC5-S link failure may also be named as a PC5-S unicast link failure or the like.
(2) A notification of failing to recover a sidelink RLF on the link between the relay UE and the abovementioned another UE.
(3) A notification of a PC5-S link failure on the link between the relay UE and the abovementioned another UE. In an example, the notification of the PC5-S link failure is received after an AS layer of the relay UE receives an indication of the PC5-S link failure. In a further example, the notification of the PC5-S link failure is received after an expiry of “a timer of keep-alive procedure”.

In another example, the PC5-S link failure is detected upon at least one of: an expiry of “a timer for keep-alive procedure” which is associated with the link between the UE and the relay UE; and an expiry of “another timer for keep-alive procedure” that is associated with the link between the UE and the abovementioned another UE.

In some embodiments, an upper layer of the UE is a PC5-S layer, and the failure notification is received from a PC5-S layer of the UE. The failure notification may be an indication of the PC5-S link failure of the link between the UE and relay UE, wherein the indication is received by an AS layer of the UE from a PC5-S layer of the UE.

In some embodiments, upon an expiry of “a timer for keep-alive procedure” which is associated with the link between the relay UE and the abovementioned another UE, an upper layer of the relay UE indicates the failure notification to a AS layer of the relay UE, and then the relay UE transmits the failure notification to the UE.

In some embodiments, after the UE receives the failure notification associated with the sidelink failure in the link between the relay UE and the abovementioned another UE, the UE suspends a transmission of data terminated in the abovementioned another UE.

In some embodiments, after the UE receives the failure notification associated with the sidelink failure in the link between the relay UE and the abovementioned another UE, the UE continues to transmit data terminated in the relay UE and continues to receive data from the relay UE.

In an embodiment, if the UE receives an end-mark indication from the relay UE, the UE stops receiving data from the relay UE. In a further embodiment, if the UE receives a RRC message including an indication of completing data forwarding terminated in the UE, the UE stops receiving data from the relay UE.

After stopping receiving data from the relay UE, the UE may release the PC5 RRC connection between the UE and the relay UE. Alternatively, an AS layer of the UE may transmit an indication to a PC5-S layer of the UE, to indicate that the UE has stopped receiving the data from the relay UE.

In some embodiments, if the UE is in coverage of the BS and if the UE detects the sidelink failure in the link between the UE and the relay UE or detects the failure in the RRC relayed connection of the link between the UE and the abovementioned another UE, the UE reports failure information to a BS.

In some embodiments, if the UE is in coverage of the BS and if the UE receives the failure notification from the relay UE, the UE reports the received failure information to a BS. In some embodiments, the failure information or the failure notification includes a failure cause. The failure cause may be at least one of:
(1) a failure regarding configuration information, and the configuration information is associated with the link between the UE and the relay UE;
(2) the sidelink failure in the link between the UE and the relay UE;
(3) the sidelink failure in the link between the relay UE and the abovementioned another UE; and
(4) the failure in a RRC relayed connection of the link between the UE and the abovementioned another UE.

In some other embodiments, the failure information or the failure notification includes a set of identity information regarding two terminated UEs of a link associated with the failure cause. Specifically, if the UE in coverage of a BS (e.g., BS 102 illustrated and shown in FIG. 1), the UE may report the failure information of the first hop link (i.e., the link between the UE and the relay UE) and an end-to-end RRC relayed connection (i.e., the RRC relayed connection between the UE and the abovementioned another UE) in a UE-to-UE scenario. The UE may also report the reception of the failure information from relay UE to the BS. For the configuration failure case, the corresponding cause (e.g., configuration failure) is added to the failure information. For PC5-S link failure, the corresponding cause (e.g., PC5-S link failure or a timer expiry) will be added to the failure information.

Details described in all other embodiments of the present application (for example, details regarding specific trigger conditions for performing a relay reselection procedure) are applicable for the embodiments of FIG. 7. Moreover, details described in the embodiments of FIG. 7 are applicable for all the embodiments of FIGS. 1-6 and 8-10.

FIG. 8 illustrates a flow chart of a method for transmitting a failure notification in accordance with some embodiments of the present application. The method may be performed by a relay UE (e.g., relay UE 103 illustrated and shown in FIG. 1, UE 201-A or UE 201-B as illustrated and shown in FIG. 2, or UE 320 as illustrated and shown in FIG. 3). Although described with respect to a relay UE, it should be understood that other devices may be configured to perform a method similar to that of FIG. 8.

In the exemplary method 800 as shown in FIG. 8, in operation 801, a PC5 RRC connection of a link between a UE (e.g., UE 101a illustrated and shown in FIG. 1) and a relay UE (e.g., relay UE 103 illustrated and shown in FIG. 1) is established. In operation 802, a RRC connection of a link between the relay UE and another UE (e.g., UE 101b illustrated and shown in FIG. 1) is established.

In operation 803, the relay UE transmits a failure notification to the UE. For instance, the failure notification transmitted from the relay UE may be:
(1) A sidelink RLF notification associated with the link between the relay UE and the abovementioned another UE. In an example, the sidelink RLF notification includes a cause. The cause is at least one of: reaching a maximum number of RLC retransmission; an expiry of “a timer for transmission of RRC reconfiguration for sidelink”; reaching a maximum number of consecutive HARQ DTX; a reception of an integrity check failure indication; and an occurrence of a PC5-S link failure.
(2) A notification of failing to recover a sidelink RLF on the link between the relay UE and the abovementioned another UE.
(3) A notification of a PC5-S link failure on the link between the relay UE and the abovementioned another UE.

In an embodiment, an AS layer of the relay UE receives an indication of the PC5-S link failure on the link between the relay UE and the abovementioned another UE, and then the relay UE transmits the notification of the PC5-S link failure to the UE.

In a further embodiment, the relay UE detects an expiry of “a timer of keep-alive procedure” which is associated with the link between the relay UE and the abovementioned another UE, and then the relay UE transmits the notification of the PC5-S link failure to the UE.

Details described in all other embodiments of the present application (for example, details regarding a failure notification) are applicable for the embodiments of FIG. 8. Moreover, details described in the embodiments of FIG. 8 are applicable for all the embodiments of FIGS. 1-7, 9, and 10.

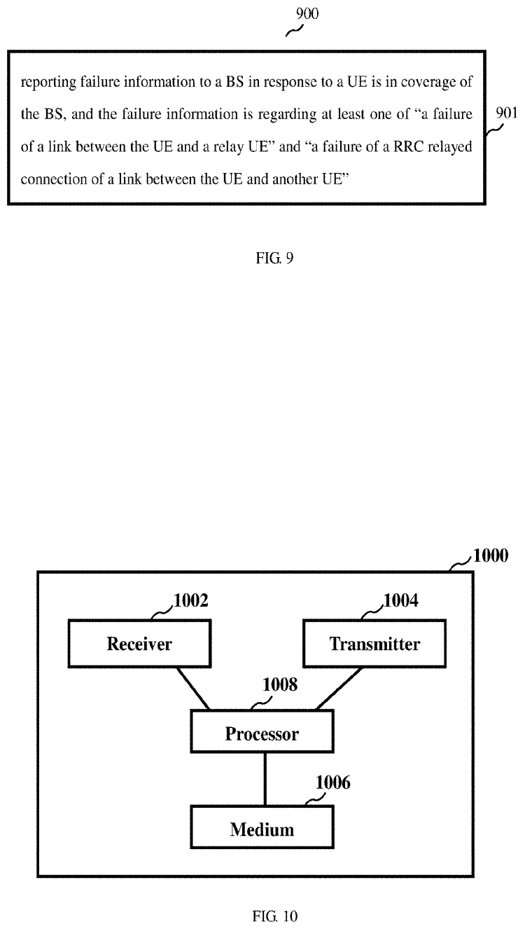

FIG. 9 illustrates a flow chart of a method for reporting failure information in accordance with some embodiments of the present application. The method may be performed by a UE (e.g., UE 101a as illustrated and shown in FIG. 1, UE 201-C as illustrated and shown in FIG. 2, UE 310 as illustrated and shown in FIG. 3, or UE 410 as illustrated and shown in FIG. 4). Although described with respect to a UE, it should be understood that other devices may be configured to perform a method similar to that of FIG. 9.

In the exemplary method 900 as shown in FIG. 9, in operation 901, if a UE (e.g., UE 101a illustrated and shown in FIG. 1 or UE 410 as illustrated and shown in FIG. 4) is in the coverage of a BS (e.g., BS 102 illustrated and shown in FIG. 1 or BS 420 as illustrated and shown in FIG. 4), the UE reports failure information to the BS. The failure information may be regarding at least one of “a failure of a link between the UE and a relay UE (e.g., relay UE 103 illustrated and shown in FIG. 1)” and “a failure of a RRC relayed connection of a link between the UE and another UE (e.g., UE 101b illustrated and shown in FIG. 1)”.

A link between the UE and a relay UE may also be named as “a first hop link between the UE and the relay UE,” “a first hop link,” or the like. A RRC relayed connection of a link between the UE and another UE may also be named as “an end-to-end RRC connection of a relayed link,” “an end-to-end RRC connection,” “an end-to-end relayed connection,” “a relayed RRC connection,” or the like.

In some embodiments, the UE may receive a failure notification or failure information from the relay UE and then report the received failure notification or failure information to the BS.

The failure information reported by the UE to the BS may include a failure cause. In an example, for a configuration failure case, the corresponding cause (e.g., configuration failure) may be added to the failure information. In a further example, for a PC5-S link failure case, the corresponding cause (e.g., a PC5-S link failure or a timer expiry) may be added to the failure information.

In some embodiments, two terminated UEs of the link may be added in the failure information reported to the BS. In an example, if a failure occurs in a link between the UE and the relay UE (i.e., a failure of a first hop link), the failure information includes identity information (e.g., destination IDs) of the UE and the relay UE. In a further example, if a failure occurs in a RRC relayed connection of a link between a UE and another UE (i.e., a failure of an end-to-end RRC connection), the failure information includes identity information (e.g., destination IDs) of the UE and the abovementioned another UE. When the BS receives the failure information, based on identity information of the terminated Ues, the BS can differentiate that a failure occurs in which of a first hop link and an end-to-end RRC connection.

Details described in all other embodiments of the present application (for example, details regarding information of a failure in a first hop link or an end-to-end RRC connection) are applicable for the embodiments of FIG. 9. Moreover, details described in the embodiments of FIG. 9 are applicable for all the embodiments of FIGS. 1-8 and 10.

The following texts describe specific Embodiments 1-3 of the methods as shown and illustrated in any of FIGS. 7-9.

### Embodiment 1

According to Embodiment 1, UE(a) (e.g., UE 101a as shown and illustrated in FIG. 1), a relay UE (e.g., relay UE 103 illustrated and shown in FIG. 1), another UE(b) (e.g., UE 101b as illustrated and shown in FIG. 1), and a BS (e.g., BS 102 as illustrated and shown in FIG. 1) perform the following steps:
(1) Step 1: A PC5 RRC connection between UE(a) and a relay UE has been established. Another PC5 RRC connection between the relay UE and UE(b) has been established.
(2) Step 2 (only for L2 relay scenario): The end-to-end RRC connection between UE(a) and UE(b) is established.
   UE(a) transmits RRCReconfiguration message for sidelink relayed connection, and the RRCReconfiguration message is relayed by the relay UE to UE(b). UE(a) starts one timer to control the procedure.
   UE(b) transmits the RRC reconfiguration for sidelink relayed connection to UE(a), which is relayed by the relay UE.
(3) Step 3: The relay UE declares a sidelink RLF for the link between relay UE and UE(b) when at least one of the following conditions happens.
   upon indication from sidelink RLC entity that the maximum number of retransmissions for a specific destination has been reached; or
   upon an expiry of timer T400; or
   upon indication from sidelink MAC entity that the maximum number of consecutive HARQ DTX; or
   upon integrity check failure indication from sidelink PDCP entity; or
   Failed keep-alive procedure:
   After the relay UE sends a Keep-alive message to UE(b), the relay UE starts one timer. If the timer expires, the upper layer will indicate it to the AS layer.
   Then, the relay UE may transmit, to UE(a), a notification of a sidelink failure or a PC5 link failure.
(4) Step 4: The relay UE transmits a failure notification to UE(a) when the relay UE declares a sidelink RLF, receives a configuration failure, or receives a failure indication of PC5-S layer from an upper layer of the relay UE.
(5) Step 5: UE(a) receives the failure notification from the relay UE. The failure information may indicate a sidelink RLF, a configuration failure, or a Layer-2 link failure in the upper layer.
   In Case 1 that a failure occurs in the second hop (i.e., the link between the relay UE and UE(b)) in both L2 relay scenario and L3 relay scenario, a trigger condition to perform a relay reselection procedure may be at least one of:
      UE(a) receives a sidelink RLF notification from the relay UE, when a RLF on the sidelink between the relay UE and UE(b) happens;
         The sidelink RLF notification may include at least one of the following sidelink RLF causes: a maximum number of RLC retransmission; T400 expiry; a maximum number of consecutive HARQ DTX; a reception of an integrity check failure indication; and a PC5-S link failure.
      UE(a) receives a notification of a sidelink RLF recovery failure from relay UE when relay UE fails to recover RLF on sidelink between the relay UE and UE(b);
      UE(a) receives a notification of a PC5-S failure from the relay UE, when the AS layer of the relay UE receives an indication of a PC5 layer link failure or when “the timer of the keep-alive procedure” expiries.
(6) Step 6: UE(a) is triggered to perform relay reselection. When the UE(a) receives the failure notification from the relay UE, UE(a) may keep the first hop link (i.e., the link between UE(a) and the relay UE) and trigger to transmit SidelinkUEinformation message to the serving BS (e.g., BS 102 illustrated and shown in FIG. 1).
   After UE(a) receives the failure notification of the link between the relay UE and UE(b), UE(a)'s behavior(s) may be as follows:
      When UE(a) receives the notification of failure from the relay UE, UE(a) may continue to keep the first hop link.
         UE(a) suspends the transmission of data terminated in UE(b), i.e., data is aimed to be transmitted to UE(b). However, UE(a) continues the transmission of data terminated in the relay UE.
         UE(a) continues to receive data from the relay UE until receiving an end-mark indication.
         UE(a) releases the PC5 RRC connection between UE(a) and the relay UE. An AS layer of UE(a) may indicate to a PC5-S layer of UE(a), when UE(a) receives an end-mark indication from the relay UE.
   UE(a) may report, to a BS (e.g., BS 102 illustrated and shown in FIG. 1), failure information of at least one of a first hop link and an end-to-end relayed connection. For example:
      If UE(a) is in the coverage of the BS, UE(a) may report, to the BS, failure information regarding the first hop link and the end-to-end RRC relayed connection. UE(a) also reports, to the BS, failure information received from the relay UE.
         For a configuration failure case, the corresponding cause (e.g., a configuration failure) is added to the failure information.
         For a PC5-S link failure case, the corresponding cause (e.g., a PC5-S link failure or a timer expiry) is added to the failure information.
   ID information regarding two terminated UEs of the link is added in the failure information reported by UE(a). Thus, when the BS receives the failure information, the BS can differentiate the first hop link and the end-to-end RRC relayed connection in which the failure occurs.

### Embodiment 2

According to Embodiment 2, UE(a) (e.g., UE 101a as shown and illustrated in FIG. 1), a relay UE (e.g., relay UE 103 illustrated and shown in FIG. 1), another UE(b) (e.g., UE 101b as illustrated and shown in FIG. 1), and a BS (e.g., BS 102 as illustrated and shown in FIG. 1) perform the following steps:
(1) Step 1: A PC5 RRC connection between UE(a) and a relay UE has been established. Another PC5 RRC connection between the relay UE and UE(b) has been established.
(2) Step 2 (only for L2 relay scenario): the end-to-end RRC connection between UE(a) and UE(b) is established.
   UE(a) transmits RRCReconfiguration message for sidelink relayed connection, and the RRCReconfiguration message is relayed by the relay UE to UE(b). UE(a) starts one timer to control the procedure.
   UE(b) transmits the RRC reconfiguration for sidelink relayed connection to UE(a), which is relayed by the relay UE.
(3) Step 3: UE(a) declares a failure of the end-to-end RRC connection between UE(a) and UE(b) based on the following condition.
   In Case 2 that a failure occurs in an end-to-end connection for L2 relay:
      The Timer expiry for L2 relay
         UE(a) transmits RRC Reconfiguration for relayed Sidelink to UE(b), which is relayed by the relay UE to UE(b). One timer is used to control the reconfiguration procedure. UE(a) starts the timer when UE(a) transmits RRC Reconfiguration for relayed Sidelink. UE(a) stops the timer when receiving the reconfiguration complete for relayed sidelink.
      An AS layer of the UE(b) receives the indication of a PC5 unicast link failure from an upper layer (e.g., a PC5-S layer).
         “The timer of keep-alive procedure” associated with the link between UE(a) and UE(b) expires.
(4) Step 4: UE(a) is triggered to perform relay reselection. UE(a) may keep the first hop link (i.e., the link between UE(a) and the relay UE) if the link between UE(a) and relay UE is still available and trigger to transmit SidelinkUEinformation message to the serving BS (e.g., BS 102 illustrated and shown in FIG. 1).
   UE(a) may report, to a BS (e.g., BS 102 illustrated and shown in FIG. 1), failure information of at least one of a first hop link and an end-to-end relayed connection. For example:
      If UE(a) is in the coverage of the BS, UE(a) may report, to the BS, failure information regarding the first hop link and the end-to-end RRC relayed connection. UE(a) also reports, to the BS, failure information received from the relay UE.
         For a configuration failure case, the corresponding cause (e.g., a configuration failure) is added to the failure information.
         For a PC5-S link failure case, the corresponding cause (e.g., a PC5-S link failure or a timer expiry) is added to the failure information.
   ID information regarding two terminated UEs of the link is added in the failure information reported by UE(a). Thus, when the BS receives the failure information, the BS can differentiate the first hop link and the end-to-end RRC relayed connection in which the failure occurs.

### Embodiment 3

According to Embodiment 3, UE(a) (e.g., UE 101a as shown and illustrated in FIG. 1), a relay UE (e.g., relay UE 103 illustrated and shown in FIG. 1), another UE(b) (e.g., UE 101b as illustrated and shown in FIG. 1), and a BS (e.g., BS 102 as illustrated and shown in FIG. 1) perform the following steps:
(1) Step 1: A PC5 RRC connection between UE(a) and a relay UE has been established. Another PC5 RRC connection between the relay UE and UE(b) has been established.
(2) Step 2 (only for L2 relay scenario): the end-to-end RRC connection between UE(a) and UE(b) is established.
   UE(a) transmits RRCReconfiguration message for sidelink relayed connection, and the RRCreconfiguration message is relayed by the relay UE to UE(b). UE(a) starts one timer to control the procedure.
   UE(b) transmits the RRC reconfiguration for sidelink relayed connection to UE(a), which is relayed by the relay UE.
(3) Step 3: UE(a) declare sidelink RLF for the link between UE(a) and relay UE when the following condition happens.
   Upon an indication from sidelink RLC entity that the maximum number of retransmissions for a specific destination has been reached; or
   upon T400 expiry; or
   upon indication from sidelink MAC entity that the maximum number of consecutive HARQ DTX; or
   upon an integrity check failure indication from sidelink PDCP entity.
   In Case 3 that a failure occurs in the first hop link (i.e., the link between UE(a) and the relay UE) in both L2 relay scenario and L3 relay scenario, a trigger condition to perform a relay reselection procedure may be at least one of:
      UE(a) receives the configuration failure from the relay UE.
         This configuration is associated with the link between UE(a) and the relay UE.
      An AS layer of UE(a) receive an indication of a PC5 unicast link failure from an upper layer of UE(a) (e.g., a PC5-S layer).
         “The timer of keep-alive procedure” associated with the link between UE(a) and the relay UE expires.
(4) Step 4: UE(a) is triggered to perform relay reselection.
   Meanwhile, UE(a) may transmit SidelinkUEinformation message to the serving BS.
   UE(a) may report, to a BS (e.g., BS 102 illustrated and shown in FIG. 1), failure information of at least one of a first hop link and an end-to-end relayed connection. For example:
      If UE(a) is in the coverage of the BS, UE(a) may report, to the BS, failure information regarding the first hop link and the end-to-end RRC relayed connection. UE(a) also reports, to the BS, failure information received from the relay UE.
         For a configuration failure case, the corresponding cause (e.g., a configuration failure) is added to the failure information.
         For a PC5-S link failure case, the corresponding cause (e.g., a PC5-S link failure or a timer expiry) is added to the failure information.
   ID information regarding two terminated UEs of the link is added in the failure information reported by UE(a). Thus, when the BS receives the failure information, the BS can differentiate the first hop link and the end-to-end RRC relayed connection in which the failure occurs.

FIG. 10 illustrates a simplified block diagram of an apparatus for a failure handling procedure in accordance with some embodiments of the present application.

In some embodiments of the present application, the apparatus 1000 may be a UE (e.g., UE 101a as illustrated and shown in FIG. 1, UE 201-C as illustrated and shown in FIG. 2, UE 310 as illustrated and shown in FIG. 3, or UE 410 as illustrated and shown in FIG. 4), which can at least perform the method illustrated in FIG. 7 or FIG. 9. In some other embodiments of the present application, the apparatus 1000 may be a relay UE (e.g., relay UE 103 as illustrated and shown in FIG. 1, UE 201-A or UE 201-B as illustrated and shown in FIG. 2, or UE 320 as illustrated and shown in FIG. 3), which can at least perform the method illustrated in FIG. 8. In some additional embodiments of the present application, the apparatus 1000 may be a BS (e.g., BS 102 as illustrated and shown in FIG. 1 or BS 420 as illustrated and shown in FIG. 4).

As shown in FIG. 10, the apparatus 1000 may include at least one receiver 1002, at least one transmitter 1004, at least one non-transitory computer-readable medium 1006, and at least one processor 1008 coupled to the at least one receiver 1002, the at least one transmitter 1004, and the at least one non-transitory computer-readable medium 1006.

Although in FIG. 10, elements such as the at least one receiver 1002, the at least one transmitter 1004, the at least one non-transitory computer-readable medium 1006, and the at least one processor 1008 are described in the singular, the plural is contemplated unless limitation to the singular is explicitly stated. In some embodiments of the present application, the at least one receiver 1002 and the at least one transmitter 1004 are combined into a single device, such as a transceiver. In certain embodiments of the present application, the apparatus 1000 may further include an input device, a memory, and/or other components.

In some embodiments of the present application, the at least one non-transitory computer-readable medium 1006 may have stored thereon computer-executable instructions which are programmed to implement the operations of the methods, for example as described in view of any one of FIGS. 7-9, with the at least one receiver 1002, the at least one transmitter 1004, and the at least one processor 1008.

Those having ordinary skills in the art would understand that the operations of a method described in connection with the aspects disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. Additionally, in some aspects, the operations of a method may reside as one or any combination or set of codes and/or instructions on a non-transitory computer-readable medium, which may be incorporated into a computer program product.

While this disclosure has been described with specific embodiments thereof, it is evident that many alternatives, modifications, and variations may be apparent to those skilled in the art. For example, various components of the embodiments may be interchanged, added, or substituted in the other embodiments. Also, all of the elements of each figure are not necessary for operation of the disclosed embodiments. For example, those having ordinary skills in the art would be enabled to make and use the teachings of the disclosure by simply employing the elements of the independent claims. Accordingly, embodiments of the disclosure as set forth herein are intended to be illustrative, not limiting. Various changes may be made without departing from the spirit and scope of the disclosure.

In this document, the terms “includes,” “including,” or any other variation thereof, are intended to cover a non-exclusive inclusion, such that a process, method, article, or apparatus that includes a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that includes the element. Also, the term “another” is defined as at least a second or more. The term “having” and the like, as used herein, are defined as “including.”

1. A method performed by a first user equipment (UE), comprising:
establishing a PC5 radio resource control (RRC) connection of a first link between the first UE and a relay UE, a RRC connection of a second link between the relay UE and a second UE having been established; and
performing a relay reselection procedure based on a trigger condition as at least one of:
detecting a sidelink failure;
detecting a failure in a RRC relayed connection of a third link between the first UE and the second UE;
receiving a failure notification from the relay UE; or
receiving a failure indication from an upper layer of the first UE.

2. The method of claim 1, wherein the failure notification received from the relay UE is one of:
a sidelink radio link failure (RLF) notification associated with the second link between the relay UE and the second UE;
a notification of failing to recover a sidelink RLF on the second link between the relay UE and the second UE; or
a notification of a PC5-signaling (PC5-S) link failure on the second link between the relay UE and the second UE.

3. The method of claim 2, where the notification of the PC5-S link failure is received after:
an access stratum (AS) layer of the relay UE receives an indication of the PC5-S link failure; or
an expiry of a timer of a keep-alive procedure.

4. The method of claim 2, wherein the sidelink RLF notification includes a cause, and the cause is at least one of:
reaching a maximum number of radio link control (RLC) retransmission;
an expiry of a timer for transmission of RRC reconfiguration for sidelink;
reaching a maximum number of consecutive hybrid automatic repeat request (HARQ) discontinuous transmission (DTX);
receiving an integrity check failure indication; or
an occurrence of the PC5-S link failure.

5. The method of claim 2, wherein the PC5-S link failure is detected based on at least one of:
an expiry of a first timer fora keep-alive procedure, the first timer for the keep-alive procedure associated with the first link between the first UE and the relay UE; or
an expiry of a second timer for the keep-alive procedure, the second timer for the keep-alive procedure associated with the third link between the first UE and the second UE.

6. The method of claim 1, wherein the failure indication is received from a PC5-signaling (PC5-S) layer of the first UE, the failure indication indicating a PC5-S link failure of the first link between the first UE and the relay UE, and is received by an access stratum (AS) layer of the first UE from the PC5-S layer of the first UE.

7. The method of claim 1, wherein the sidelink failure occurs in the first link between the first UE and the relay UE, and wherein the sidelink failure is at least one of:
a radio link failure (RLF) in the first link between the first UE and the relay UE; or
a configuration failure of configuration information that is associated with the first link between the first UE and the relay UE.

8. The method of claim 1, wherein the failure in the RRC relayed connection of the third link between the first UE and the second UE is detected based on at least one of:
an expiry of a first timer for a RRC reconfiguration procedure, the first timer for the RRC reconfiguration procedure is associated with the RRC relayed connection of the third link between the first UE and the second UE; or
an expiry of a second timer for a keep-alive procedure, the second timer for the keep-alive procedure is associated with the third link between the first UE and the second UE.

9. The method of claim 1, wherein:
in response to an expiry of a timer for a keep-alive procedure, the failure notification is indicated from an upper layer of the relay UE to an access stratum (AS) layer of the relay UE, the timer for the keep-alive procedure is associated with the second link between the relay UE and the second UE; and
the failure notification is transmitted by the relay UE to the first UE.

10. The method of claim 1, further comprising:
in response to receiving the failure notification associated with the sidelink failure in the second link between the relay UE and the second UE, suspending a transmission of data terminated in the second UE.

11. The method of claim 1, further comprising:
in response to receiving the failure notification associated with the sidelink failure in the second link between the relay UE and the second UE, continuing to transmit first data terminated in the relay UE and continuing to receive second data from the relay UE.

12. The method of claim 11, further comprising:
stopping receiving the second data from the relay UE in response to:
receiving an end-mark indication from the relay UE; or
receiving a RRC message including an indication of completing data forwarding terminated in the first UE.

13. The method of claim 12, further comprising:
releasing the PC5 RRC connection between the first UE and the relay UE.

14. The method of claim 11, further comprising:
transmitting, by an access stratum (AS) layer of the first UE, an indication to a PC5-signaling (PC5-S) layer of the first UE, wherein the indication indicates that the first UE has stopped receiving the second data from the relay UE.

15. An apparatus, comprising:
a receiver;
a transmitter; and
a processor coupled to the receiver and the transmitter configured to cause the apparatus to:
establish a PC5 radio resource control (RRC) connection of a first link between the apparatus and a relay user equipment (UE), a RRC connection of a second link between the relay UE and a UE having been established; and
perform a relay reselection procedure based on a trigger condition as at least one of:
detection of a sidelink failure;
detection of a failure in a RRC relayed connection of a third link between the apparatus and the UE;
a reception of a failure notification from the relay UE; or
a reception of a failure indication from an upper layer of the apparatus.

16. An apparatus, comprising:
a receiver;
a transmitter; and
a processor coupled to the receiver and the transmitter configured to cause the apparatus to:
establish a PC5 radio resource control (RRC) connection of a first link between a first user equipment (UE) and the apparatus;
establish a RRC connection of a second link between the apparatus and a second UE; and
transmit a failure notification to the first UE.

17. The apparatus of claim 16, wherein the failure notification is one of:
a sidelink radio link failure (RLF) notification associated with the second link between the apparatus and the second UE;
a notification of failing to recover a sidelink RLF on the second link between the apparatus and the second UE; or
a notification of a PC5-signaling (PC5-S) link failure on the second link between the apparatus and the second UE.

18. The apparatus of claim 17, wherein the sidelink RLF notification indicates a cause of the failure notification as at least one of:
reaching a maximum number of radio link control (RLC) retransmission;
an expiry of a timer for transmission of RRC reconfiguration for sidelink;
reaching a maximum number of consecutive hybrid automatic repeat request (HARQ) discontinuous transmission (DTX);
a reception of an integrity check failure indication; or
an occurrence of the PC5-S link failure.

19. The apparatus of claim 16, wherein, to transmit the failure notification to the first UE, the processor coupled to the receiver and the transmitter is configured to cause the apparatus to:
receive, by an access stratum (AS) layer of the apparatus, an indication of the PC5-S link failure on the second link between the apparatus and the second UE; and
transmit the failure notification of the PC5-S link failure to the first UE.

20. The apparatus of claim 16, wherein, to transmit the failure notification to the first UE, the processor coupled to the receiver and the transmitter is configured to cause the apparatus to:
detect an expiry of a timer of a keep-alive procedure, the timer for the keep-alive procedure being associated with the second link between the apparatus and the second UE; and
transmit a notification of a PC5-signaling (PC5-S) link failure to the first UE.
